(19) United States
(12) Patent Application Publication
(10) Pub. No.: US 2016/0262397 A1
(43) Pub. Date: Sep. 15, 2016

(54) EQUINE HOOF TREATMENT

(71) Applicant: Joseph Mastroianni, Lake Worth, FL (US)

(72) Inventor: Joseph Mastroianni, Lake Worth, FL (US)

(21) Appl. No.: 14/645,685

(22) Filed: Mar. 12, 2015

(51) Int. Cl. A01N 53/00; A01N 45/00; A01N 25/00; A01L 15/00

(52) U.S. Cl. CPC A01N 53/00; A01L 15/00; A01N 45/00; A01N 25/00

(57) ABSTRACT

An equine hoof treatment includes a mixture of hoof oil and permethin. The mixture is placed on the hoof of a horse to condition the hoof, encourage healing thereof, and preventing biting insects from biting the horse below the knee.

### BACKGROUND OF THE DISCLOSURE

### Field of the Disclosure

The disclosure relates to anti insect hoof treatment compositions and more particularly pertains to a new anti insect hoof treatment composition for placing on a horse hoof to condition the hoof while preventing biting insects from biting the horse from the hoof and up to the knee.

### SUMMARY OF THE DISCLOSURE

An embodiment of the disclosure meets the needs presented above by generally comprising a mixture of hoof oil and permethin. The mixture is placed on the hoof of a horse to condition the hoof, encourage healing thereof, and preventing biting insects from biting the horse below the knee.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### DESCRIPTION OF THE PREFERRED EMBODIMENT

A new anti insect hoof treatment composition embodying the principles and concepts of an embodiment of the disclosure will be described.

The equine hoof treatment generally comprises a composition comprising a mixture of hoof oil and permethin. More particularly, the mixture includes by weight at least 25% hoof oil and 25% permethin and more preferably about 50% hoof oil and 50% permethin. The hoof oil may be any conventional hoof oil widely available for purchase. Such hoof oils may include a variety of ingredients but may include in particular petroleum jelly, anti-fungus/anti-bacterial ointment, mineral oils and the like. One example of hoof oil is Farriers' Fix available from Farriers Fix Inc., 38 Village Green, Bedford, N.Y. Hydrocortisone may also be added to the hoof oil such that it comprises between 0.25% and 2.0% of the horse oil.

Permethin has the molecular formula C₂₁H₂₀CL₂O₃, has the IUOAC designation 3-Phenoxybenzyl (1RS)-cis,trans-3-(2,2-dichlorovinyl)-2,2-dimethylcyclopropanecarboxylate, and is known by the trade name Nix. Permethin is widely available and will act as repellant for insects and in particular biting insects such as mosquitoes, gnats and flies.

In use, the mixture is spread on the hoof of a horse in a conventional manner as is typically done with horse oil. The horse oil component conditions and moisturizes hoof while the permethin repels biting insects.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An equine hoof ointment and insect repellant composition comprising:
a mixture including by weight:
50% permethrin; and
50% hoof oil, said hoof oil including hydrocortisone.

2. An equine hoof ointment and insect repellant composition comprising:
permethrin; and
hoof oil.

3. An equine hoof ointment and insect repellant composition comprising:
a mixture including by weight:
greater than 25% permethrin; and
greater than 25% hoof oil.

4. (canceled)
